(19) United States
(12) Patent Application Publication
(10) Pub. No.: US 2008/0312956 A1
(43) Pub. Date: Dec. 18, 2008

(54) Method for proxy development, maintenance and upgrading of pharmaceutical formulary and software tool therefor

(75) Inventors: Paul M. Momita, San Diego, CA (US); Alan P. Levis, San Diego, CA (US)

Correspondence Address: GORDON & REES LLP, 101 WEST BROADWAY, SUITE 1600, SAN DIEGO, CA, 92101, US

(73) Assignee: Medimpact Healthcare Systems, Inc.

(21) Appl. No.: 11/818,277

(22) Filed: Jun. 14, 2007

(51) Int. Cl. G06Q 50/00; G06F 17/30; G06F 17/40

(52) U.S. Cl. 705/2

(57) ABSTRACT

A method of operating a formulary and software therefore comprising a unique formulary maintenance tool are disclosed which allows for much greater participation of a PBM In the maintenance and upgrading of formularies. The method and software allow the PBM to create a wide range of useful and efficient proxies (“top down” operation) and not wait for organizations such as CMS or clients to define specific and limited drugs (“bottom up” operation). The system retains the ability to incorporate CMS- and client-defined proxies but also allows the PBM to create such proxies on its own from competent source information. It also includes sorting, navigation, comparison and communication capabilities which will result in significantly more efficient claim adjudication and system maintenance.

### FIELD OF THE INVENTION

The present invention relates generally to the field of prescription drug benefits plans and more particularly to the development and maintenance of drug formularies used in the operation of such plans.

### BACKGROUND OF THE INVENTION

Prescription drug benefit management involves formularies of thousands of prescription drugs in both generic and branded forms with their various dosages forms, strengths and costs. In addition, many prescription benefits plans (including broader medical and health benefit plans that include a prescription drug benefit) specify formularies which are individual to a plan or to a small group of plans, so a prescription benefit manager (PBM) normally maintains a significant number of different formularies required for the PBM's clients. To cope with all these data and be able to process (adjudicate) prescription payment claims efficiently, PBMs have used a number of techniques for constructing and operating their formularies.

One of these techniques has been the use of proxies. A “proxy” is a drug which is selected as “representative” of a group of drugs in the formulary, all of which are considered to share some significant similar property or properties. In the operation of the formulary, the formulary operator develops all the relevant parameters needed for adjudication for that proxy drug and determines the appropriate pharmacy compensation to be paid for filling a prescription for that drug for a patient. There may be and often are several different compensation amounts, depending on factors including the drug's “attributes,” the generic or proprietary status of the drug, and limitations on payment defined by the patient's particular prescription benefit plan. Other known factors may also be present in payment determination, as those skilled in the art will recognize. A drug's “attributes” for a specific prescription or adjudication, as used herein, are its brand name, its generic name, its dosage form, its strength and its “route” of administration to the patient (commonly abbreviated as the “BGSDR” information about the drug). Once the proxy drug's appropriate compensation amount or amounts have been determined, the formulary operator (the PBM) can then use those amounts for all of the other drugs which are in the group for which the first drug is the proxy. Adjudicative time and effort is thus saved, patients' prescriptions are approved for payment more quickly and pharmacies are compensated more quickly, since each individual drug prescribed does not have to undergo individual determination of all of the payment determination factors. Yet other benefits include ease of review and maintenance of the system.

Because of the fact that drug prescriptions for Medicare and Medicaid participants under Medicare Part D constitute such a large segment of the prescription drug marketplace, formulary considerations raised or directed by the Centers for Medicare & Medicaid Services (CMS) within the U.S. Department of Health and Human Services (HHS), which administer Medicare and Medicaid, are a major factor in determination of formulary operations by PBMs. CMS has endorsed the use of proxies and has developed a “Proxy National Drug Code” (“Proxy NDC”) which is the basis for formularies under Medicare Part D. However, a PBM cannot rely solely on the CMS Proxy NDC. First, it is limited in scope and does not cover BGSDRs for many drugs which are under the scope of the Medicare Part D benefit, but nonetheless may be required for claims adjudication. Further, it is updated by CMS to define additional or upgraded proxies only infrequently, commonly only about once per month. Formulary operators have therefore developed their own proprietary formularies to cover not only “CMS drugs” but also “non-CMS drugs,” i.e., those drugs which either are ineligible for Medicare and therefore outside the CMS Proxy NDC or which may be eligible but have not yet been incorporated into the Proxy NDC by CMS. Of course new drugs are not introduced on any set schedule, and BGSDR updates of existing drugs also are done at random times. Other clients for whom PBMs manage individualized formularies which include non-CMS drugs or new drugs expect their formularies to be revised when such new drugs appear or current drugs are updated in a manner more timely than waiting for a periodic CMS Proxy NDC update. However, incorporation of these into formularies by PBMs often has not necessarily been done in a systematic way and approval of these revised formularies for use for Medicare Part D and under numerous commercial prescription drug benefit plans has often not been granted by CMS and/or various plans. CMS has recognized the problems and has called upon those in the prescription benefit field (including PBMs) to develop improved methods for structuring, administering, maintaining and upgrading formularies for use for Medicare Part D prescription patients. Many private prescription benefit plan owners recognize the current shortcomings as well, and it is anticipated that development of new formulary methods (and their associated management “tools”) that meet with CMS's approval will also be approved by those owners.

It is therefore evident that there is a current and pressing need for new and improved formulary methods and tools to deal effectively and efficiently with adjudication of pharmacy reimbursement claims for the burgeoning inventory of prescription drugs and the expansion of both Medicare Part D and private commercial drug benefit plans. It is to this goal that the unique and superior formulary benefit management methods and tools of the present invention are directed, as will be evident from the descriptions and claims which follow below.

### SUMMARY OF THE INVENTION

The method of the current invention utilizes a unique novel formulary maintenance tool which allows for much greater participation of the PBM In the maintenance and upgrading of formularies. The method itself differs significantly from prior formulary operation and maintenance methods in that it embodies what can most simply be described as a “top down” method of operation, maintenance and upgrading rather than the prior “bottom up” methods. Conceptually this means that the PBM takes a leading role in creating a wide range of useful and efficient proxies (“top down”) and does not wait for organizations such as CMS or clients to define specific and limited proxies (“bottom up”). The system of course retains the ability to incorporate the CMS- and client-defined proxies but goes well beyond that to encompass creation of BGSDR information and drug proxies based on various sources much more frequently than the CMS schedule. It also includes sorting, navigation and comparison capabilities which will result in significantly more efficient claim adjudication and system maintenance.

A critical element in the new method is that it allows the PBM to create proxies based on unique drug BGSDR combinations which are then used to characterize each available proxy NDC and assign each new proxy NDC its unique characteristics, which are then used to define which proxy NDC's appear for each managed plan and how frequently they appear. Similarly, it allows the PBM to update existing proxies on similarly frequently schedules.

### BRIEF DESCRIPTION OF THE DRAWING

FIG. 1, the single FIGURE of the drawings, is a block diagram illustrating the method of operation of a drug formulary using the novel formulary maintenance tool of the present invention.

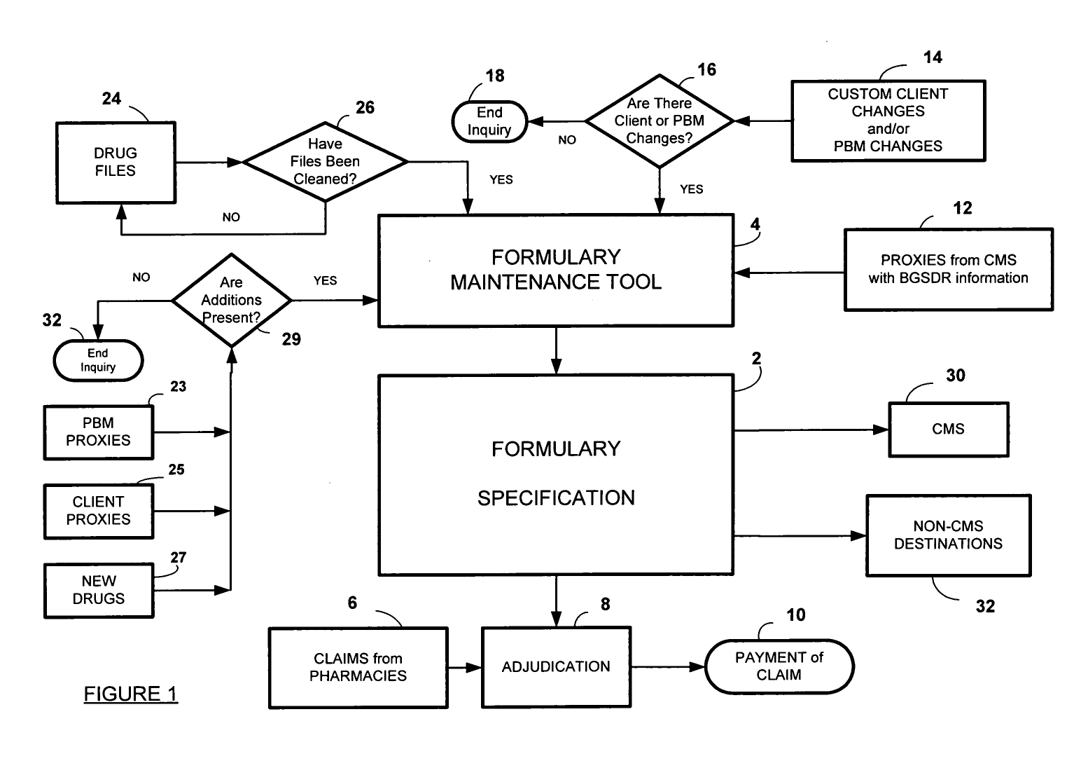

### DETAILED DESCRIPTION OF THE INVENTION

The system initially may be best understood by reference to the single FIGURE of the drawings. The key elements are the formulary specification 2 and the formulary maintenance tool 4. The formulary specification 2 is the database which contains all of the required drug information and the characteristics of each of the proxies. It is the database from which the PBM draws the information to process claims 6 from pharmacies and conduct adjudications 8 resulting in payments 10 to the pharmacies of the claims 6 for prescriptions dispensed to members of the various prescription drug benefit plans that the PBM manages.

The formulary maintenance tool 4 is unique to this invention and is the software-based means by which the PBM structures, maintains and upgrades the formulary specification 2. The principal types of inputs to the tool 4 are shown in the FIGURE along with the types of decisions that the PBM will make during operation of the tool 4. At the most basic level the tool 4 receives proxies 12 from CMS with their included BGSDR information and these are incorporated into the formulary 2 under procedures defined by CMS. The tool 4 also allows the PBM to make such revisions to the CMS proxies as may be permitted by CMS.

The step at 25 allows the PBM to account for proxies which may be received from client sources. A critical and unique element of the invention is the step at 23, which allows the PBM to create proxies on its own. The step at 27 allows the PBM to account for new adjudicable drugs that it has become aware of, whatever the source of the information. The PBM at decision point 29 determines which of the new proxies or drugs are to be added to be formulary 2 by means of the tool 4. If there are no new proxies or drugs to be considered, or if any considered are not deemed appropriate for addition to the formulary 2, the inquiry is ended at 32.

A related operational component of the tool 4 illustrated at 14 and allows the PBM to incorporate other formulary changes or custom instructions provided by the PBM's clients 20 or the PBM itself against available CMS and non-CMS proxies. When the tool 4 is operated, the software provides the opportunity at 16 for the PBM to determine whether or not there are any new proxies or changes that should be incorporated into the fommulary 2. Principal sources of such information are the PBM's clients, one or more of whom may wish to have their managed formularies revised accordingly. However, the PBM is not limited only to client sources, but can use the tool 4 to add other drugs and create other proxies based on information received from other competent sources. The incorporation by the PBM of some or all of the various additions and revisions to the managed formularies will be in accordance with the instructions of the clients and the terms of the management agreements between the clients and the PBM. If there are no additions or changes to be made, that inquiry is ended and the tool operation continues. At this point the tool 4 also allows the PBM to modify requested changes from the clients 20.

The system also provides for ongoing and periodic reviews of the drug files 24 to insure that data in the formulary 2 are current and correct. At decision point 26 the PBM can conduct limited or global reviews of the files 24 and upgrade, correct or delete files as necessary.

It will be evident to those skilled in the art that the various steps and decisions described above may be performed in any convenient order during operation of the tool 4 and need not be performed in the order described, and further that at many times not all of the inputs and decisions will be pending to be made. It will also be evident that operation of the tool 4 is not limited to only the inputs and decisions described, but will also include such internal structuring, maintenance, upgrading and other operations with respect to the formulary 2 that the PBM may wish to make at any time, whether or not there are inputs of the types described above that are currently pending.

It is contemplated that such additions, revisions, updates and other changes to various managed formularies will be made by the PBM on substantially a daily basis, and communications to clients as to the updated status of their formularies will be made with a frequency of approximately 7-10 days, i.e., generally approximately a weekly basis, so that all client formularies will be effectively current whenever a patient in a managed plan chooses to have a prescription filled. To the extent that the PBM is also permitted by CMS to make such changes to the CMS portions of the formularies at those intervals (which are significantly more frequent than CMS's own updates), the PBM will normally do so on the PBM's update schedule.

The system also is capable of electronic (or other media) correspondence with CMS at 30 and non-CMS destinations, such as clients, at 32. This will enable information about the PBM-generated proxies to be communicated to CMS and clients, as well as other entities who may have an interest. It is contemplated that entities such as CMS and clients will elect to incorporate some or all of the PBM-generated proxies into their own formularies or formulary-related information and data files.

The software used in the formulary specification 2 includes a function to automatically relate a new proxy or representative drug in an NDC to the list of all NDCs which may be associated with that proxy or drug. The software maps between such NDCs and results in a list of all covered adjudicable NDCs. It also translates formulary specifications into adjudicable formularies, which results in creation of a drug list, tier associations and edits of applications.

The tool provides core Part D formulary functions defined by CMS, including maintenance of BGSDR, proxy and drug data; formulary maintenance based on drug data changes, including maintenance coding for all formularies, production of ASCII formulary files and production of plan finder files. Such maintenance is performed periodically, preferably on an essentially weekly (i.e., 7-10 day) schedule, although shorter or longer maintenance intervals can be used. Negative change notifications generated by CMS can also be accommodated, including production of explanation of benefits (EOB) future formulary changes files.

For the software functions discussed herein the specific software codes used are not critical. It is contemplated that various coding languages, structures and programming can be used to accomplish the functions for the purposes described herein. Those skilled in the art will understand the functions and be able readily to create code to accomplish the functions. This enables users of the invention to integrate the functions of the invention with functions of other aspects of their own formulary systems. The tool 4 of this invention and all of its functions may thereby be tailored by coding choices of the PBM and other users to be fully compatible with their own prior formulary software. It is therefore not believed necessary to illustrate code herein, since those skilled in the art being appraised of the functions of the present invention will easily recognize code compatible with their own formulary systems. Users will thus be able to integrate the unique tool of the present invention into their formulary systems and thereby be able to achieve the enhanced maintenance, upgrading, proxy development, structuring and formulary administration that are provided by this tool.

Operational functions in the tool 4 are exhibited to the operator through a conventional visual monitor. Menus in pull-down or other formats allow the operator to work through the various choices and selections for development of proxies, use of prior proxies and adjudication of claims based on the proxies. Typically the monitor screens will present the operator with menus of functions for both periodic drug updates as well as complete full formulary review. Formulary review is contemplated as a three step process, starting with a formulary update (on a full or periodic basis), a comparison of formulary changes entered with those proposed, and verification of the changes and/or approval according to formulary management protocols. Under the enhanced capabilities of the present invention, many of those changes will be instigated by the PBM, such as the release of newly available proxy NDCs. Where the changes are generated by CMS or a PBM client, the review protocols will normally include submission to the formulary proprietor PBM for concurrence and approval for inclusion in the formulary.

The software preferably defaults to screens showing all basic review data fields. However, the software may also permit the operator to redesign a screen to show only certain fields, to simplify operation when it is not anticipated that changes or updates being entered or reviews will extend over and involve all data fields. Such redesign does not normally permit deletion of any field; rather the redesign merely defines which fields appear on the screen, with the other fields merely being temporarily “hidden” but maintained off-screen. This aspect of the present invention also includes tiered permission capabilities, in which potential users are grouped into tiers with respect to their need to have an ability to modify (temporarily or permanently) any aspect of the present system and its software. Tier permission criteria will normally be defined by the PBM formulary operator, with exceptions made where the PBM believes appropriate for selected clients, or which specific regulations (such as promulgated by CMS) may require. Most operators will have low tier permission, which for instance may allow only modifications which make minor cosmetic changes to the appearance of the screens. It will normally be only a few operators who will have higher tier permissions for more substantive modifications, in the manner of “administrator” status in many software systems.

The operation of the formulary tool is facilitated by inclusion of three types of default parameters: default filters, default values and default rules. Default filters limit the number of proxies that appear on a user's screen for review. Such filters thereby improve the efficiency of the review process, since only the proxies related to the user's specific need at that time appear on the screen. The user thus does not waste time sorting through large numbers of proxies, many of which are not relevant to the user's current task. Default values are used to provide the initial population of the utilization management parameters necessary for the proper adjudication of claims, to the value that the system initially recognizes as being of most relevance to the operator's current inquiry. The system does permit the operator to manually override or adjust the populated values as necessary. Default rules are used to provide initial formulary placement decisions based on the criteria incorporated into the rules. Such default rules are incorporated into new proxies as appropriate upon development of the new proxy. As with the default values, default rule assignations may be manually overridden or adjusted as necessary. A mechanism whereby default parameters, default values and default rules are defined and maintained is included in the formulary tool 4.

Other adjudication criteria commonly present in prescription benefit plans are present in the tool herein. Among such adjudication criteria are drug quantity limits (based on a ratio basis, quantity per time period or quantity per prescription fill); type of authorization required for approval of a claim; and effective dates for the validity of the formulary tier and utilization management rules. Those skilled in the art will recognize these and numerous other criteria which are commonly present in various plans, either on a universal (or nearly universal) basis or on a custom basis in a single or a few plans. Such criteria may be added to the tool software either by the PBM proprietor of the formulary or, if appropriate, by a user for a user-specific plan. The tool software is preferably further enhanced by the inclusion of “grandfathering” and/or “memory” rules. These make management and operation of the system more efficient since under these rules the system remembers past approved adjudications for identified patients and permits continued adjudication on that basis within certain predetermined time periods.

Although several embodiments of the invention have been described above by way of example only, it will be understood by those skilled in the field that numerous variations and modifications may be made to the disclosed embodiments without departing from the scope or spirit of the invention, as it is defined by the appended claims.

We claim:

1. A method for operation of a pharmaceutical drug formulary specification database useful for adjudication of payment of reimbursement claims made with respect to fulfillment of prescriptions for drugs identified therein, which comprises:
a. providing initial content of said database comprising identification data on a first plurality of pharmaceutical drugs including attributes of each drug in said plurality;
b. providing software to enable an operator of said database to incorporate into said database identification data on at least one additional pharmaceutical drug including attributes thereof, thus enlarging said first plurality;
c. providing software to enable said operator of said database to revise, maintain and upgrade said identification data of all said drugs in said database; and
d. providing software to enable said operator of said database to designate at least one drug in said database as an adjudication proxy for a drug group comprising said designated drug and at least one other drug in said database;
such that said adjudication of payment of reimbursement claims for either of said designated drug and said other drug can be simplified by consideration only of said adjudication proxy.

2. A method as in claim 1 wherein said drug group comprises said designated drug and a second plurality of said other drugs from within said first plurality, all said drugs in said second plurality having attributes which for the purpose of said adjudication of payment are considered to be comparable to said attributes of said designated drug.

3. A method as in claim 1 wherein said attributes of a drug comprise one or more of said drug's brand name, generic name, dosage form, strength and route of administration.

4. A method as in claim 1 wherein said operator of said database comprises a prescription benefit plan manager.

5. A method as in claim 1 wherein said software further enables said operator of said database to create, revise, maintain, upgrade and delete any designation of a drug in said database as an adjudication proxy.

6. A method as in claim 1 wherein said identification data of said drugs in said database are obtained from at least one source.

7. A method as in claim 6 wherein sources are selected from the group comprising said operator of said database, governmental entities and entities who are parties to prescription benefit plan agreements.

8. A method as in claim 7 wherein said operator of said database comprises a prescription benefit plan manager.

9. A method as in claim 7 further wherein said software also accommodates designation by a source other than said operator of at least one drug in said database as an adjudication proxy for a drug group comprising said designated drug and at least one other drug in said database.

10. A method as in claim 9 wherein said software further enables said operator of said database to create, revise, maintain, upgrade and delete such designation of a drug in said database as an adjudication proxy by said source other than said operator.

11. A method as in claim 1 further wherein said software enables said operator to communicate information from said database to other entities.

12. A method as in claim 11 wherein said other entities comprise governmental agencies and clients of said operator.

13. A method as in claim 11 wherein said information communicated comprises identification of at least one adjudication proxy definition generated by said operator.

14. A method as in claim 11 wherein communication from said operator to at least one said entity comprises updated information about formulary changes made by said operator since a prior communication to said entity, and the interval between successive said communications to said entity in on the order of 7-10 days.

15. Software for operation of a pharmaceutical drug formulary specification database useful for adjudication of payment of reimbursement claims made with respect to fulfillment of prescriptions for drugs identified therein, which comprises:
a. a first functionality providing initial content of said database comprising identification data on a first plurality of pharmaceutical drugs including attributes of each drug in said plurality;
b. a second functionality to enable an operator of said database to incorporate into said database identification data on at least one additional pharmaceutical drug including attributes thereof, thus enlarging said first plurality;
c. a third functionality to enable said operator of said database to revise, maintain and upgrade said identification data of all said drugs in said database; and
d. a fourth functionality to enable said operator of said database to designate at least one drug in said database as an adjudication proxy for a drug group comprising said designated drug and at least one other drug in said database;
such that said adjudication of payment of reimbursement claims for either of said designated drug and said other drug can be simplified by consideration only of said adjudication proxy.

16. Software as in claim 15 further comprising another functionality for recognition of said attributes of said designated drug and attributes defining a second plurality of said other drugs from within said first plurality, all said attributes being for the purpose of said adjudication of payment considered comparable.

17. A method as in claim 15 wherein said attributes of a drug comprise one or more of said drug's brand name, generic name, dosage form, strength and route of administration.

18. Software as in claim 15 further comprising another functionality to enable said operator of said database to create, revise, maintain, upgrade and delete any designation of a drug in said database as an adjudication proxy.

19. Software as in claim 15 further comprising another functionality to accommodate designation by a source other than said operator of at least one drug in said database as an adjudication proxy for a drug group comprising said designated drug and at least one other drug in said database.

20. Software as in claim 19 wherein functionality further enables said operator of said database to create, revise, maintain, upgrade and delete such designation of a drug in said database as an adjudication proxy by said source other than said operator.

21. Software as in claim 15 further comprising another functionality to enable said operator to communicate information from said database to other entities.

22. Software as in claim 15 comprising a formulary maintenance tool.

23. Software as in claim 22 where said tool enables an operator of said database to enhance, revise, maintain and upgrade said database by addition to, modification of or deletion of any data related to any drug or proxy in or being introduced into said database.
